(19) United States
(12) Patent Application Publication
(10) Pub. No.: US 2012/0125986 A1
(43) Pub. Date: May 24, 2012

(54) STICKER SHEETS AND WRAPPING MATERIAL

(76) Inventor: Robert Walton, Reading (GB)

(21) Appl. No.: 13/140,969

(22) PCT Filed: Dec. 18, 2009
(86) PCT No.: PCT/GB2009/051746

§ 371 Date: Feb. 10, 2012

(30) Foreign Application Priority Data
Dec. 19, 2008 (GB) 0823257.1

(51) Int. Cl. B65D 65/22; G09F 3/10; C09J 7/02; B65D 65/28

(52) U.S. Cl. 229/87.05; 428/40.1; 428/42.1

(57) ABSTRACT

An adhesive sticker sheet is disclosed comprising a plurality of adhesive stickers for securing wrapping material about an article. The stickers are arranged on a backing sheet such that at least one pair of stickers are adjoining. In one example the adhesive stickers are arranged to be contiguous across substantially the entire backing sheet. Sticker positions are indicated by markings on the reverse of the backing sheet. A method of manufacturing the sticker sheet is also disclosed. Also disclosed is material for wrapping articles, comprising a sheet having a plurality of lines of weakness subdividing the sheet into a plurality of shapes independently separable from the sheet, each shape adapted for the wrapping of an article.

The present invention relates to the wrapping of articles. The invention has particular, although not exclusive, relevance to the wrapping of gifts—although the principle of the invention may also be advantageous in other fields. The invention also relates to adhesive stickers, in particular to be applied to gift wrap.

Gift wrap commonly comprises wrapping material such as paper, supplied either on a roll or in sheet form, which the user cuts to the required size for wrapping the gift. The frustrations encountered when wrapping gifts with conventional gift wrapping paper are well known. The process requires the use of a cutting tool such as a knife or scissors to cut the paper. These are potentially dangerous, so unsuitable for children to use unsupervised. They may also not be immediately available, which often results in the use of a scoring and tearing method (perhaps in combination with an edge, such as a ruler) which can damage the gift wrapping paper. Furthermore, use of conventional gift wrapping paper is wasteful, as cutting the paper often results in unsuitable and unwanted off-cuts.

Securing the gift within the wrapping paper typically also requires use of some adhesive tape, which also needs to be cut to length before being used to secure the gift wrapping. This also requires the use of a cutting tool, typically scissors or alternatively a blade (commonly serrated) located within a tape dispensing device, which further makes the gift-wrapping process unsuitable for children to use unsupervised. Where such a cutting tool is unavailable, this often results in attempts to tear the tape directly which, even if eventually successful, can be wasteful of tape.

The entire gift wrapping process is awkward as a fair degree of manual dexterity is required to achieve simultaneously obtaining suitable strips of tape whilst keeping the gift suitably enclosed in the gift wrap. Strips of adhesive tape are therefore commonly temporarily adhered to a convenient surface, potentially resulting in the surface being damaged.

There is therefore a need for an improved wrapping system which would be more convenient, less wasteful and also safer (so as, for example, to allow children to wrap gifts with minimal supervision).

### Adhesive Sticker Sheet

According to a first aspect, the invention provides an adhesive sticker sheet comprising a plurality of adhesive stickers for securing wrapping material about an article, the stickers being arranged on a backing sheet such that at least one pair of stickers are adjoining. Said pair of stickers may be nearest neighbour stickers.

Providing the adhesive stickers in this way may reduce waste.

Preferably, the adhesive stickers are arranged to be contiguous, preferably across substantially the entire backing sheet. This may further reduce waste.

In an alternative embodiment, spacings are provided between stickers. These spacings may be provided between rows or columns of stickers. In a further alternative, spacings may be provided between individual stickers. The spacings may make it easier to engage with the edge of a sticker and hence separate it from the backing.

In any embodiment, the adhesive stickers may form part of an adhesive sheet supported on the backing, having a plurality of lines of weakness or cuts subdividing the sheet into a plurality of stickers independently separable from the sheet.

Preferably, the lines of weakness comprise perforations. Alternatively, the lines of weakness may comprise scored or cut lines. This may make the adhesive sticker sheet easier to manufacture. Where the stickers are cut or perforated this is preferably done without cutting or perforating the backing sheet. Preferably, the stickers are formed by a kiss cutting process.

Preferably, the lines of weakness or cuts are arranged such that the plurality of stickers extends across the entire or substantially the entire area of the sheet. This may reduce waste.

Preferably, the stickers are arranged in a (two-dimensional) contiguous block, which may be a grid of equal or differing shapes and/or sizes. A plurality of the stickers preferably adjoin other stickers on at least one side, preferably on two sides. For example, the stickers may be arranged in adjoining columns or rows, with or without spacings between the columns or rows (stickers at the ends of a column or row would in that case only adjoin another sticker on one side). Preferably, the stickers are arranged to adjoin other stickers on all sides except those sides which are at the periphery of the block or sheet, to thus form a contiguous block or sheet. In the case of rectangular/square stickers, at least some stickers preferably adjoin other stickers on all four sides. However, other (e.g. interlocking) shapes may be provided which are arranged contiguously on the sheet so that the stickers (except those at the periphery) adjoin other stickers on most or all sides. The block of stickers may extend to the edges of the adhesive sheet or there may be an unused border area on one, more or each side of the adhesive sheet. Preferably, stickers adjoin other stickers along (substantially) the entirety of one or more sides.

Preferably the stickers are in the form of strips (e.g. substantially rectangular shapes). Preferably the sheet comprises strips of a plurality of different lengths. However, in a preferred embodiment, all the strips on the sheet have (substantially) the same width. This aspect may also be provided independently as set out below.

Preferably, sticker positions (preferably edges or corners) are indicated by markings. The markings may indicate one or more edges or corners of the stickers, for example each upper left corner may be marked. These may aid in identification of a suitable available sticker and also aid in separating a sticker from the backing. These markings may be located on the backing sheet or on the sticker. In a preferred embodiment, the markings are applied to the reverse of the backing sheet in such a way that the markings are discernible from the front of the sticker sheet (i.e. through the stickers and backing sheet). This may simplify manufacture. Also, by applying markings to the reverse of the sticker sheet, the visual appearance of the stickers is not diminished. In a particular embodiment, the markings are printed markings, preferably printed on the reverse of the backing sheet so as to be visible through the backing sheet and stickers (the stickers and/or the backing sheet may be transparent or partially transparent or translucent), for example by using dark ink and/or printing heavily. Alternatively the markings may be embossed. Other suitable methods of marking the stickers or backing sheet may be used.

Preferably, the markings are in the form of outlines, such as grid lines, printed on the reverse of the backing sheet, which correspond to the sticker shapes.

Preferably, the adhesive stickers further comprise means for aiding manual lifting of the stickers from the backing sheet. This may aid in engaging with the edge of a sticker and hence separating it from the backing. Preferably, the means for aiding manual lifting comprise a formation on the perimeters of some or each of the stickers. This formation may be a relatively small cut out, such as a cut corner, or a lifting tab.

Preferably, the position of the means for aiding manual lifting of the stickers is indicated by a marking. This may aid in identification of the said means. The marking may be a logo or a theme indicator.

Preferably, the adhesive sheet further comprises means for anchoring the sheet to a working surface. This may make it easier to remove stickers from the sheet. The means for anchoring may comprise a suction pad or a clip or both a suction pad and a clip. Alternatively, the means for anchoring may comprise an adhesive pad. In a further alternative, the means for anchoring may comprise a magnet. In a yet further alternative, the means for anchoring may comprise a first anchoring element located on the adhesive sheet adapted to interface with a corresponding second anchoring element located on the working surface.

Preferably, the adhesive stickers are transparent or translucent. The adhesive stickers may be coloured. The adhesive stickers may be decorated. The decoration may be a motif, for example, a logo. The surface of the adhesive stickers may be writeable on i.e. the surface of the adhesive stickers may be roughened or comprise an ink absorbing layer in order to facilitate the marking of the surface by pen or other writing or marking implement. The adhesive sticker may be adapted to prevent erasure of such markings.

The stickers may all be of the same shape or may have different shapes. In one embodiment, the sheet includes a plurality of differently-shaped stickers. This aspect is also provided independently. Accordingly, in another aspect, the invention provides for adhesive means in the form of an adhesive sticker sheet, comprising a sheet of differently-shaped adhesive stickers supported on a backing. Multiple stickers of each of a plurality of shapes may be present.

The shapes of the adhesive stickers on a particular adhesive sticker sheet may comprise at least one of the following: circle, square, oblong, rectangular, elliptical, irregular shape. The shapes may be themed.

The adhesive stickers may all be of the same size. Alternatively, the adhesive stickers may be of different sizes. Multiple stickers of each of a plurality of sizes may be provided. The dimensions of the adhesive stickers may be factors of the dimensions of the adhesive sticker sheet. For example, the lengths of the adhesive stickers may be one, half, a third, a quarter, an eighth or some other integer fraction of the length of the adhesive sticker sheet.

Preferably, the adhesive sticker sheet is A5 size. The sticker sheet may be A4 size. The adhesive sticker sheet may be a standard paper or envelope size.

Each sticker preferably has adhesive on only one side. In other words, each sticker preferably includes an adhesive face (against the backing sheet) and a non-adhesive face. In preferred embodiments, the sticker layer in which the stickers are formed is formed from a given (non-adhesive) material (e.g. paper or polypropylene), to which a layer of adhesive material (such as a conventional adhesive) has been applied.

The stickers preferably have a thickness of between 30-120 μm, more preferably between 40-80 μm, still more preferably between 50-70 μm. The stickers preferably have a thickness of between 55-65 μm, preferably approximately 59 μm or approximately 60 μm. The stickers preferably have a tensile strength of between 20-60 N/cm, preferably 30-50 N/cm, more preferably approximately 40 N/cm. The stickers preferably have an elongation at break value of between 20-60%, more preferably 30-50%, still more preferably approximately 40%. The stickers preferably have a peel adhesion of between 2-10 N/cm, preferably 4-8 N/cm, more preferably approximately 6 N/cm.

Preferably, the adherence of the adhesive stickers to the wrapping material gift wrap is insufficient to cause tearing of the wrapping material when the adhesive stickers are removed from the wrapping material. This may allow for the adhesive stickers to be repositionable.

In a further aspect of the invention, there is provided an adhesive sticker sheet comprising a plurality of adhesive stickers for securing wrapping material about an article, the stickers being arranged on a backing sheet, wherein one or more markings are provided on the backing sheet indicating the positions of one or more of the stickers to assist in removal of the stickers.

The markings are preferably applied to the reverse of the backing sheet.

The markings are preferably arranged to be discernible, preferably visible, through the stickers and, where applied to the reverse of the backing sheet, through the backing sheet, e.g. by use of dark ink and/or thick lines as described elsewhere herein.

The markings preferably indicate one or more edges or corners of one or more stickers, and preferably comprise lines.

The stickers preferably form part of an adhesive sheet supported on the backing, having a plurality of lines of weakness or cuts subdividing the sheet into a plurality of stickers independently separable from the sheet, wherein the markings correspond to locations of lines of weakness or cuts. The markings may correspond to corners, edges or outlines of the stickers and/or comprise a grid of lines corresponding to sticker borders or outlines. The markings (e.g. lines) are preferably positioned substantially directly below (when viewed from above and through the sheet) the corresponding sticker edges, corners, cuts, or lines of weakness so as to give a clear indication of the sticker positions, and of sticker edges or corners in particular.

In a further aspect, the invention provides an adhesive sticker sheet comprising a plurality of adhesive stickers for securing wrapping material about an article, the stickers preferably being arranged in a contiguous block on a backing sheet, the block preferably extending across (substantially) the entire backing sheet (i.e. the stickers preferably extend contiguously across substantially the entire backing sheet, though in other embodiments the sheet may include an unused border area surrounding the contiguous block on one or more sides), wherein the stickers are in the form of a plurality of strips, each strip being substantially equal in width, the sheet comprising strips of a plurality of different lengths. This can provide a particularly convenient arrangement of stickers suitable for use in gift wrapping.

In a further aspect, the invention provides a method for manufacturing an adhesive sticker sheet in accordance with any embodiment as set out herein. In a particular aspect, the invention provides a method of making an adhesive sticker sheet, comprising: receiving an adhesive sheet comprising an adhesive sticker layer arranged on a backing sheet; applying lines of weakness to the adhesive sticker layer or cutting the adhesive sticker layer to subdivide the sheet into a plurality of contiguous stickers independently separable from the sheet; and applying markings to the reverse of the backing sheet (for example by printing), the markings indicating the position of stickers in the adhesive sticker layer, the markings arranged to be visible through the sticker layer and backing sheet.

In a further aspect, the invention provides adhesive means, comprising a sheet of differently-shaped adhesive stickers supported on a backing, wherein the stickers are arranged in oblong shapes without spacings between the stickers.

Other features may include one or more of the following:
Transparent
Coloured/decorative
Only oblongs and circles
   Oblongs and/or circles of varying sizes
Oblongs leaving no waste between them
Sheet form
   Weight/thickness of the sheet between stipulated limits e.g. sheet size 210 mm×207 mm
   so s/a paper crackback clear tape front slit
   Tape no printing. . . .
   Several sheets with different/the same:
      Sizes e.g. two A5, one A4
      Shapes
      Colours
   Anchoring means e.g. a suction pad (potentially in combination with or alternatively a small clip), for attaching sheet to surface to allow stickers to be pulled off sheet more easily
Combination in a clear hanging bag with logo, with four sheets of mixed sizes, with logos on the adhesive stickers for easy peel, easy peel edges, with a device to attach to a surface

### Advantages:

convenience, ease of use
   no need to search for end of tape as with conventional roll tape
   no need to prepare cut lengths of tape before beginning to wrap
   no need to find temporary place to stick the cut lengths of tape before use
      avoids possible damage to surfaces
safety—no need to cut tape from roll

### Gift Wrap

According to a further aspect, the invention provides material for wrapping articles, comprising a sheet having a plurality of lines of weakness subdividing the sheet into a plurality of shapes independently separable from the sheet, each shape adapted for the wrapping of an article.

This may make the wrapping material more convenient and safer to use than conventional wrapping material as there is no need to use a cutting implement such as scissors or to use an edge such as a ruler.

Each shape is adapted for the wrapping of an article. Thus, preferably, the lines of weakness do not merely subdivide the sheet into small units of equal or related dimensions, whereby a number of units can be selected to achieve a desired size, but instead each shape is individually arranged to be of a size which is adequate for wrapping an individual article. For this reason (in particular but not exclusively when the shapes are substantially rectangular or square), preferably at least one shape (optionally several or all shapes of the sheet) has a shortest dimension of at least 10 cm, more preferably at least 12.5 cm, still more preferably at least 15 cm. Preferably at least one shape, optionally several or all shapes of the sheet, has a shortest dimension of at least 17.5 cm, more preferably at least 20 cm, still more preferably at least 25 cm. At least one, several or all shapes of the sheet may have minimum measurements of 10 cm, 12.5 cm, 15 cm, 17.5 cm, 20 cm or 25 cm for both dimensions.

Preferably, the lines of weakness comprise perforations. Alternatively, the lines of weakness may comprise scored lines or, alternatively, the lines of weakness may result from the material being weakened at those places by, for example, application of heat or pressure, or the introduction of an impurity into the material. This may also improve safety, as the edges of the sheet may not be as sharp as those obtained by cutting the sheet.

Preferably, the lines of weakness are arranged such that the plurality of shapes extends across the entire or substantially the entire area of the sheet. This may reduce waste.

Preferably, at least one of the shapes is of a different size to the other shapes. All the shapes may be of different sizes. This may allow for differently sized articles to be wrapped. Indeed, these important features may be provided independently of any other, or in appropriate combination with any other. At least one of the shapes (preferably multiple or all shapes) may be suitable for the wrapping of standard-sized articles, such as books, CDs, DVDs, or video games (and hence may have dimensions suitable for wrapping corresponding standard media cases such as CD, DVD, and video game cases).

At least one of the shapes may have dimensions suitable for wrapping a so-called “jewel case”, the jewel case preferably being of dimensions at least 200 mm×150 mm×20 mm, or at least 150 mm×130 mm×15 mm, or at least 142 mm×125 mm×10 mm, or exactly 142 mm×125 mm×5 mm.

At least one of the shapes may have dimensions suitable for wrapping a so-called “keep case”, preferably of dimensions at least 250 mm×200 mm×30 mm, or at least 200 mm×140 mm×20 mm, or at least 190 mm×135 mm×14 mm.

Preferably, at least one of the shapes is a rectangle. Most or all of the shapes may be rectangles. Again, these important features may be provided independently of any other, or in appropriate combination with any other.

At least one shape may be a square. Most or all of the shapes may be squares.

Preferably, the sheet further comprises fold markings to assist a user with folding the sheet. The fold markings may be present on at least one shape. Preferably, the fold markings are present on most if not all shapes.

Preferably the sheet further comprises positioning markings to assist a user with positioning the article for wrapping. The positioning markings may be present on at least one shape. Preferably, the positioning markings are present on most if not all shapes. The positioning markings may be labelled to indicate the suitable dimensions of the article. For each shape, the positioning marking may be suitable for positioning standard-sized articles, such as books, CDs or DVDs. The positioning marking may comprise an outline of the article, such as the outline of a “jewel case” or “keep case”. Alternatively, the positioning marking may comprise edge or corner delimiters indicating where the edges or the corners of the article are to be placed. The positioning markings may be labelled (for example, with the words “CD” or “DVD”) to indicate the type of article to which they refer. Additional marking may indicate the dimensions of the sheet and of individual shapes.

Preferably, the sheet comprises material of a weight of no more than 200 gsm. More preferably, the material comprises material of a weight of no more than 160 gsm, yet more preferably no more than 80 gsm. Preferably, the sheet comprises material of a weight no less than 50, or 80, or 100, or 120 gsm.

As used herein, the gsm unit is preferably understood as gram-per-square metre (g·m⁻²), as known to those skilled in the art of paper technology. Where a different material is used, the use of corresponding units may be used such that the sheet exhibits similar properties (such as folding ability) suitable for gift wrapping.

Preferably, the sheet material comprises paper, or alternatively card. The sheet material may be metallised or plasticised.

Preferably, an edge of the sheet and/or an edge of one or more shapes comprises an adhesive. The adhesive may be protected by a peelable protective layer.

Preferably, the sheet material is decorated. The decoration may be one or more of: colour, image, design, logo, branding. Different decorations may be on the same sheet. Some or all of the plurality of shapes that are independently separable from the sheet, each shape adapted for the wrapping of an article, may be decorated differently.

The decoration may be personalised. The personalisation may involve the customer submitting required personalisation details to the manufacturer (or representative) by email or other electronic means. Hence the invention extends to a method of wrapping articles, the articles preferably being wrapped with material as aforesaid, the method preferably including the step of personalising decoration, the personalising step preferably including receiving personalisation details from a user.

Preferably, the sheet material comprises a 700 mm×1000 mm printed area.

Preferably, the sheet material is printed in 4-colour.

Preferably, the material for wrapping articles further comprises a second sheet of wrapping material.

Preferably, the second sheet is identical to the first sheet. Alternatively, the second sheet differs from the first sheet in at least one of the following aspects: size, colour, material, shapes, size of shapes, decoration.

Preferably, the material is suitable for wrapping an article such as a bottle. This aspect may be provided independently.

### Gift Wrap Package

According to another aspect, the invention provides a wrapping system, set or kit, comprising material for wrapping articles as set out above in combination with one or more adhesive sticker sheets as set out above.

Other features may include one or more of the following:
Combination of gift wrap and tape—themed, mixed
   Combination boxed in one box—or bag
   Combination of gift wrap and adhesive sticker sheet for particular article such as book, CD or DVD
   Combination for multiple articles such as two CDs and four books
   Combination with matching themes of gift wrap and tape
      Theme indicated on the box lid
      Optionally including any combination of:
         a pen—possibly with logo
         at least one gift tag
         at least one bow

### Advantages:

convenience, ease of use—self-contained package of all elements required for gift wrapping kept together, allowing for simultaneous one-stop purchase of elements required for the wrapping of an article such as a gift and also allowing for easy storage for future use.

### General Features

Embodiments may provide one or more of the following features:
Easy-to-use wrapping paper and tape, just fold away for next time.
All designs can be unique with a pack of mixed paper in all different sizes.
Can be designed for all different Department stores etc,
Also can be designed for individuals i.e. birthdays, mother day, Xmas etc
No more scissors
No more tearing or ripping
No more paper cuts
No more adhesive tape in your mouth
No more pulling the varnish off your table
Pre-cut wrapping paper
Can comes in various sizes:
   Small box
   Small book box
   Medium choc box
   Medium toys
   Large box
   Extra large box
   Giant box
   Also available in mixed sizes (large and small etc)
   Also, wrap bottles with ‘Bottle it bags’
Comes in different pre-cut sizes

The invention extends to methods, apparatus and/or materials substantially as herein described with reference to the accompanying drawings. Any feature in one aspect of the invention may be applied to other aspects of the invention, in any appropriate combination.

These and other aspects of the present invention will become apparent from the following exemplary embodiments that are described with reference to the accompanying figures in which:

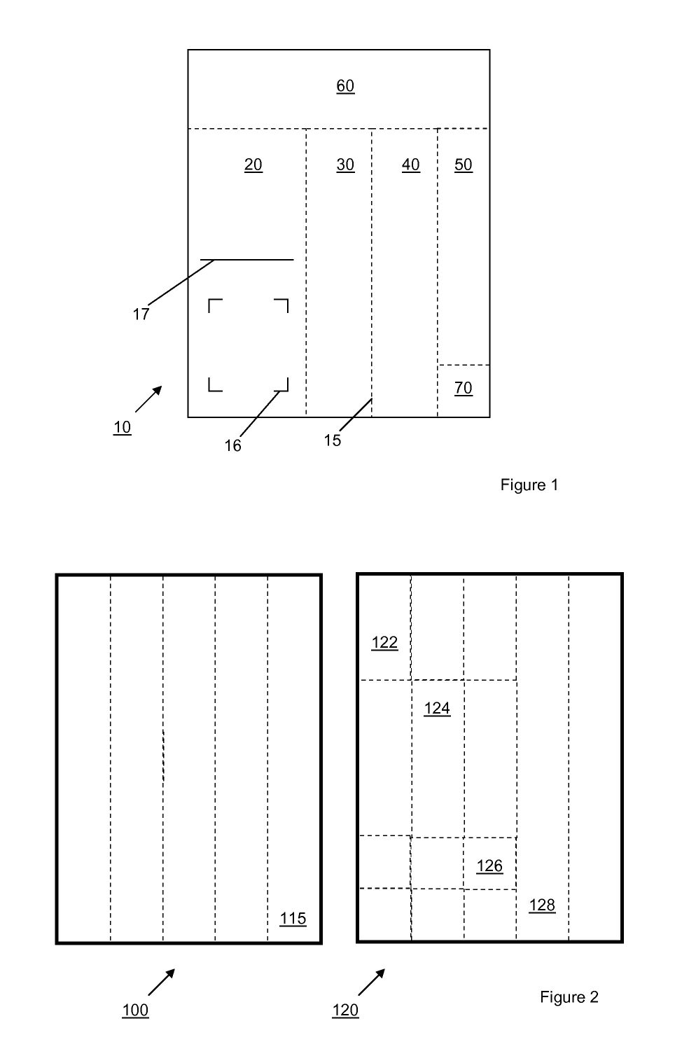

FIG. 1 shows a sheet of gift wrap;

FIG. 2 shows two different adhesive sticker sheets;

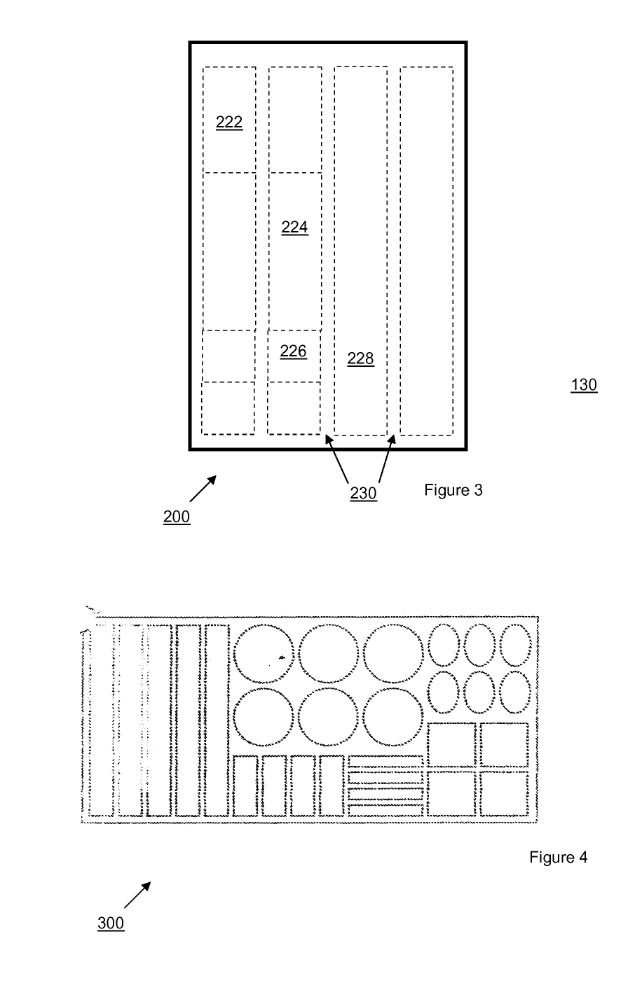

FIG. 3 shows an adhesive sticker sheet with inter-sticker spacings;

FIG. 4 shows an adhesive sticker sheet with a plurality of different stickers;

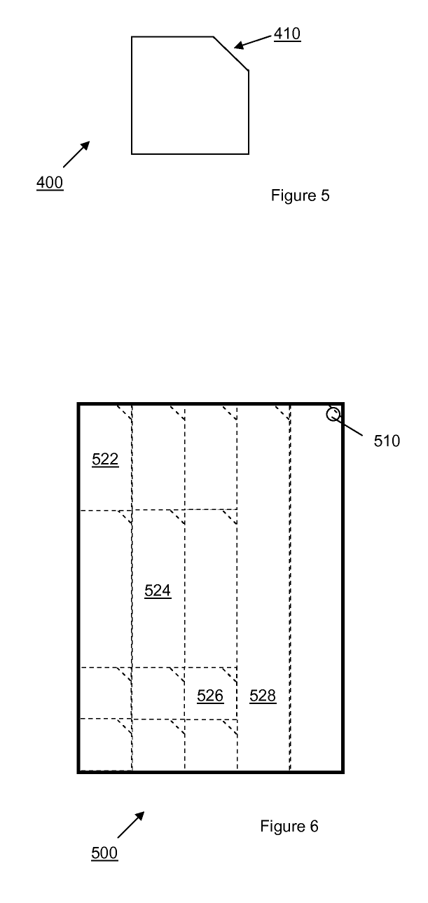

FIG. 5 shows an adhesive sticker with a cut-away corner;

FIG. 6 shows an adhesive sticker sheet with cut-away corners;

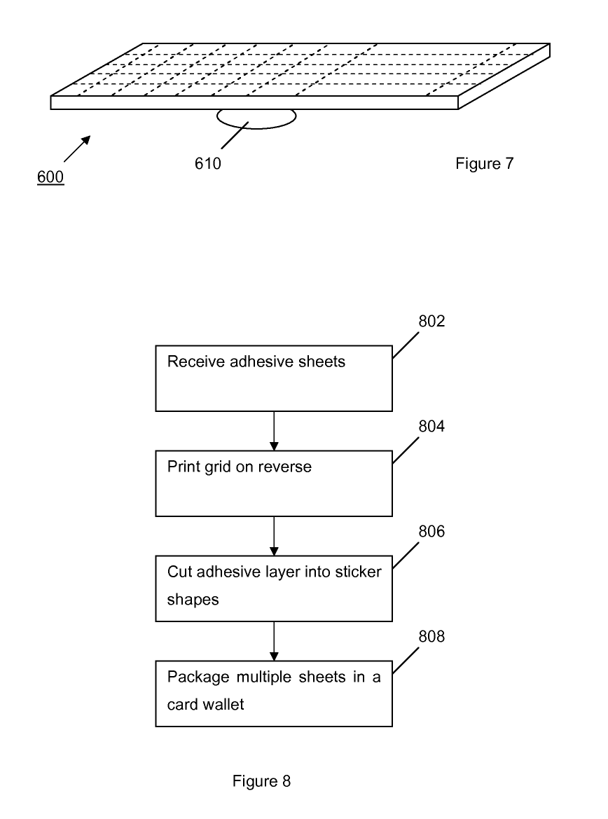

FIG. 7 shows an adhesive sticker sheet with anchoring device;

FIG. 8 illustrates a manufacturing process for manufacturing a pack of sticker sheets;

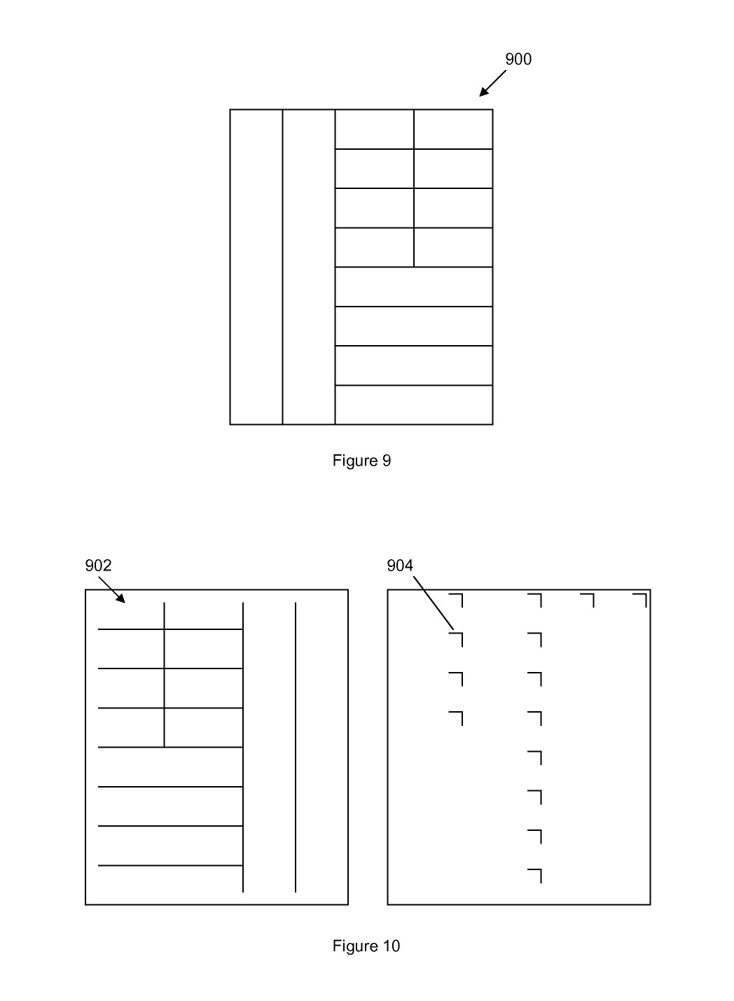

FIG. 9 shows sticker shapes and dimensions for a sticker sheet; and

FIG. 10 shows two examples of markings printed on the reverse of a sticker sheet.

### GIFT WRAP

FIG. 1 shows a sheet of gift wrap 10. The sheet 10 has been divided up by means of perforations 15 into a plurality of rectangular shapes 20, 30, 40, 50, 60, 70. A user is therefore able to use the perforations 15 to tear off the rectangular shapes 20, 30, 40, 50, 60, 70 from the main body of gift wrap sheet 10 and use the shape as a separate piece of gift wrap material (or multiple shapes may be used together as a single piece if required).

One or more of the shapes (e.g. shape 20) may be arranged in size and shape for the wrapping of a standard article such as a CD or DVD, and may include markings to assist in wrapping. In this example, shape 20 includes positioning markers 16 to aid in positioning the standard-sized article and a fold line 17 to assist in folding the shape at the right place. Any suitable arrangement of positioning and fold markers may be used, depending on the intended article.

Sheet 10 is made of 80 gsm paper, although the use of alternative paper weights is possible. For example, a premium gift wrapping material may comprise a paper of a higher paper density or grammage, such as 120 gsm or higher. Alternatively, a different material may be used, such as a strong metallised plastic, which may result in a premium gift wrap of lower density.

As an alternative to perforations 15, scored lines may be used, or the material may be materially altered by, for example application of heat or pressure, or the introduction of an impurity into the material.

### Adhesive Sticker Sheet

FIG. 2 shows an adhesive sticker sheet 100 of rectangular adhesive stickers 115 and another adhesive sticker sheet 120 of variously sized rectangular adhesive stickers 122, 124, 126, 128 supported on a backing sheet (not visible in the figure). The adhesive stickers are arranged to be contiguous across substantially the entire backing sheet, that is, there are no spacings between adjoining adhesive stickers so as to make use of the entire backing sheet surface.

FIG. 3 shows a sheet 200 of variously sized rectangular adhesive stickers 222, 224, 226, 228 with inter-sticker spacings 230 between columns of stickers. The spacings allow for easier engagement with the stickers and facilitate their removal from the backing sheet.

FIG. 4 shows a sheet 300 of adhesive stickers with a plurality of differently sized and shaped stickers, including stickers which are rectangular, circular, and elliptical.

FIG. 5 shows an adhesive sticker 400 with a cut-away corner 410. The cut away corner 410 allows for easier engagement with the sticker 400 and facilitates its removal from the backing sheet.

FIG. 6 shows a sheet 500 of variously sized rectangular adhesive stickers 522, 524, 526, 528 with cut-away corners, the position of one cut-away corner being indicated by a marking 510 to facilitate its location by the user of the adhesive sticker sheet 500.

FIG. 7 shows an adhesive sticker sheet 600 of adhesive stickers anchored by means of a suction pad 610 to a working surface (not shown).

FIG. 8 illustrates a manufacturing process for manufacturing a pack of sticker sheets in accordance with an embodiment of the invention. First, in step 802, pre-manufactured adhesive sheets are received. Each sheet comprises a single uncut transparent adhesive sticker layer arranged on a backing sheet. In step 804, a grid corresponding to the sticker shapes is printed on the reverse side of the backing sheet. The grid is preferably printed with sufficiently dark ink and/or sufficiently thick lines so that the grid is at least somewhat visible from the front of the sheet, i.e. through the adhesive sticker layer and backing sheet, to assist the user in identifying the sticker locations/boundaries. Alternatively, a partial grid or other indication may be printed, for example showing the location of sticker corners by way of line segments, dots or other indications. Other information, such as manufacturer/product indications and instructions for use may also be printed. In step 806, the stickers are cut into the desired shapes and sizes by a kiss-cutting process, which cuts through the adhesive sticker layer to form the stickers without cutting through the backing sheet (though an impression may be left on the backing sheet, which may help in identifying the sticker boundaries with or without the printed grid mentioned above). In step 808 multiple sheets are packaged in a card wallet or other suitable packaging. The card wallet may have product information and the like printed on it, and may include a window for inspection of a portion of a sheet inside.

In a preferred embodiment, the sheet dimensions are 120 mm×152 mm, and the card wallet (when assembled) is 130 mm×180 mm. The card wallet is assembled from a pre-printed 285 mm×255 mm card sheet (e.g. by folding and gluing).

FIG. 9 illustrates a sticker sheet 900 in accordance with another embodiment of the invention. The sheet is divided into stickers of different shapes and sizes (two long strips measuring 152 mm×19 mm; four medium-length strips measuring 82 mm×19 mm, and 8 short strips measuring 41 mm×19 mm, though other specific dimensions could be used), in a grid arrangement. Adjacent stickers directly adjoin, so that the strips together form a contiguous block. The stickers extend to the edges of the sheet (120 mm×152 mm as indicated above).

FIG. 10 illustrates two examples of corresponding markings that may be printed on the reverse of the backing sheet to assist in locating stickers. In the first example, the markings are in the form of a complete or substantially complete grid 902 corresponding to the sticker outlines. In the second example, a plurality of individual corner markers 904 are printed at locations corresponding (on the front of the sheet) to the upper left-hand corners of each sticker (the markings in each case are mirrored to ensure they match up with the sticker shapes when printed on the reverse of the sheet).

Thus, the stickers are arranged in a plurality of different shapes/sizes, with multiple stickers for each shape/size. The stickers are in the form of differently-sized strips each having the same width (19 mm) but different lengths. This arrangement is particularly suitable for gift wrapping, where the required width typically does not vary but the required length does.

Technical characteristics of adhesive tape are commonly described in terms of four key variables: thickness; tensile strength (the force required to stretch the tape by a certain amount); elongation at break (the amount by which the tape may be stretched before breaking); and peel adhesion (the force required to pull a stuck piece of tape free from a surface).

In certain preferred embodiments, the adhesive stickers described herein may have the following properties:
Thickness—Preferably between 30-120 μm, more preferably 40-80 μm. In a preferred embodiment the thickness is between 50-70 μm, more preferably between 55-65 μm. In a particularly preferred embodiment the thickness is approximately 60 μm, or exactly 59 μm. This can provide adhesive stickers which are slightly thicker than some conventional sticky tapes and thus easy to handle, but thinner than some conventional reinforcing tapes. In another embodiment, stickers with a thickness of between 60-120 μm or more particularly 80-110 μm may be used, for example approximately 90 μm.
Tensile strength—preferably 20-60 N/cm, more preferably 30-50 N/cm. In a preferred embodiment the stickers have a tensile strength of approximately 40 N/cm.
Elongation at break—preferably 20-60%, more preferably 30-50%, still more preferably approximately 40%. This can provide stickers which can stretch more than conventional sticky tape before breaking. However, in other embodiments, a lower value closer to conventional sticky tape may be used, for example 10-30%, more preferably 15-25%, or approximately 20%.
Peel adhesion—preferably 2-10 N/cm, more preferably 4-8 N/cm. This can provide stickers which are easy to handle yet have sufficient adhesive strength to reliably secure gift wrap. In some embodiments the stickers may have peel adhesion of approximately 6 N/cm.

However, other embodiments may have other values for the above properties, outside the indicated ranges, depending on requirements.

In one preferred example the sticker sheet uses transparent polypropylene with a thickness of 59 microns for the stickers, which are backed with permanent adhesive and provided on a 110 micron thick kraft liner backing sheet.

It will be understood that the present invention has been described above purely by way of example, and modification of detail can be made within the scope of the invention.

1. An adhesive sticker sheet comprising:
a plurality of adhesive stickers for securing wrapping material about an article, the stickers being arranged on a backing sheet such that at least one pair of stickers is adjoining.

2. The adhesive sticker sheet according to claim 1, wherein the adhesive stickers are arranged to be contiguous, preferably across substantially the entire backing sheet.

3. The adhesive sticker sheet according to claim 1, wherein spacings are provided between stickers, preferably between rows or columns of stickers.

4. The adhesive sticker sheet according to claim 1, wherein spacings are provided between individual stickers.

5. The adhesive sticker sheet according to claim 1, wherein the adhesive stickers form part of an adhesive sheet supported on the backing, having a plurality of lines of weakness or cuts subdividing the sheet into a plurality of stickers independently separable from the sheet.

6. The adhesive sticker sheet according to claim 5, wherein the lines of weakness comprise perforations or scored lines.

7. The adhesive sticker sheet according to claim 5, wherein the lines of weakness or cuts are arranged such that the plurality of stickers extends across the entire or substantially the entire area of the sheet.

8. The adhesive sticker sheet according to claim 1, wherein the stickers are in the form of a plurality of strips, the sheet comprising strips of a plurality of different lengths.

9. The adhesive sticker sheet according to claim 1, wherein sticker positions are indicated by markings.

10. The adhesive sticker sheet according to claim 9, wherein the markings are located on the backing sheet or on the sticker.

11. The adhesive sticker sheet according to claim 9, wherein the markings are printed on the reverse side of the backing sheet so as to be visible through the backing sheet and stickers.

12. The adhesive sticker sheet according to claim 9, wherein the markings indicate one or more edges or corners of one or more stickers, the markings preferably comprising lines.

13. The adhesive sticker sheet according to claim 1, the adhesive stickers further comprising means for aiding manual lifting of the stickers from the backing sheet.

14. The adhesive sticker sheet according to claim 13, wherein the means for aiding manual lifting comprises a formation on the perimeter of a sticker, preferably a cut out or a lifting tab.

15. The adhesive sticker sheet according to claim 13, wherein the position of the means for aiding manual lifting of the stickers is indicated by a marking.

16. The adhesive sticker sheet according to claim 1, further comprising means for anchoring the sheet to a working surface.

17. The adhesive sticker sheet according to claim 16 wherein the means for anchoring comprises one or more of: a suction pad; a clip; an adhesive pad; and a magnet.

18. The adhesive sticker sheet according to claim 16 wherein the means for anchoring comprises a first anchoring element located on the adhesive sheet adapted to interface with a corresponding second anchoring element located on the working surface.

19. The adhesive sticker sheet according to claim 1, wherein the adhesive stickers are transparent.

20. The adhesive sticker sheet according to claim 1, comprising a plurality of differently-shaped adhesive stickers.

21. The adhesive sticker sheet according to claim 1, wherein the stickers have at least one of the following:
a thickness of between 30-120 μm;
tensile strength of between 20-60 N/cm;
an elongation at break value of between 20-60; or
a peel adhesion of between 2-10 N/cm.

22-25. (canceled)

26. An adhesive sticker sheet comprising:
a plurality of adhesive stickers for securing wrapping material about an article, the stickers being arranged on a backing sheet, wherein one or more markings are provided on the backing sheet indicating the positions of one or more of the stickers to assist in removal of the stickers.

27. The adhesive sticker sheet according to claim 26, wherein the markings are applied to the reverse of the backing sheet.

28. The adhesive sticker sheet according to claim 26, wherein the markings are arranged to be discernible, preferably visible, through the stickers and, where applied to the reverse of the backing sheet, through the backing sheet.

29. The adhesive sticker sheet according to claim 26, wherein the stickers form part of an adhesive sheet supported on the backing, having a plurality of lines of weakness or cuts subdividing the sheet into a plurality of stickers independently separable from the sheet, wherein the markings correspond to locations of lines of weakness or cuts.

30. The adhesive sticker sheet according to claim 26, wherein the markings correspond to corners, edges or outlines of the stickers and/or comprise a grid of lines corresponding to sticker borders.

31. An adhesive sticker sheet comprising:
a plurality of adhesive stickers for securing wrapping material about an article, the stickers being arranged in a contiguous block on a backing sheet, wherein the stickers are in the form of a plurality of strips, each strip being substantially equal in width, the sheet comprising strips of a plurality of different lengths.

32. The adhesive sticker sheet according to claim 31, wherein the stickers extend contiguously across substantially the entire backing sheet.

33-54. (canceled)

55. A wrapping system or set, comprising:
one or more adhesive sticker sheets as claimed in claim 1;
in combination with material for wrapping articles, comprising a sheet having a plurality of lines of weakness subdividing the sheet into a plurality of shapes independently separable from the sheet, each shape adapted for the wrapping of an article.

56. The adhesive sticker sheet according to claim 8, wherein each strip has substantially the same width.
